(19) United States
(12) Patent Application Publication
(10) Pub. No.: US 2009/0308879 A1
(43) Pub. Date: Dec. 17, 2009

(54) METHOD OF DISTRIBUTING BEER

(76) Inventor: James H. Johnson, JR., Lexington, KY (US)

Correspondence Address: KING & SCHICKLI, PLLC, 247 NORTH BROADWAY, LEXINGTON, KY, 40507, US

(21) Appl. No.: 11/996,719

(22) PCT Filed: Jul. 24, 2006
(86) PCT No.: PCT/US06/28640

§ 371 Date: Jan. 24, 2008

Related U.S. Application Data
(60) Provisional application No. 60/702,476, filed on Jul. 26, 2005.
(60) Provisional application No. 60/771,371, filed on Feb. 8, 2006.
(60) Provisional application No. 60/784,816, filed on Mar. 22, 2006.

(51) Int. Cl. A47F 1/04; G06Q 90/00; G06Q 30/00

(52) U.S. Cl. 220/592.18; 705/500; 705/14.49

(57) ABSTRACT

A method of distributing beer includes the steps of providing a beer staging structure adjacent a retail location for the sale of beer, stocking beer in the structure and advertising for the beer on the structure.

This application claims the benefit of U.S. provisional patent application Ser. No. 60/702,476 filed on 26 Jul. 2005, Ser. No. 60/771,371 filed on 8 Feb. 2006 and Ser. No. 60/784,816 filed on 13 Mar. 2006.

### TECHNICAL FIELD

The present invention relates generally to the distributing and marketing of a product and, more particularly, to a method of distributing and marketing beer.

### BACKGROUND OF THE INVENTION

Many product vendors including particularly but not exclusively limited to beer and soft drink vendors experience high transportation costs and management challenges in providing just-in-time delivery services to their high demand retail customers. Typically those retail customers require daily or every other day delivery of products such as beer, soft drinks, sports drinks, milk and the like. It is a significant management challenge to design and develop an efficient delivery system to meet retailer demand. Further, transportation costs have recently spiked due to increases in gasoline and diesel fuel prices. Significantly, further gasoline and diesel fuel price increases are anticipated.

The present invention relates to a method for staging product wherein transportation and man hour costs may be reduced dramatically by staging inventory onsite at retailer locations. Such an approach also simplifies the development and coordination of delivery schedules.

### SUMMARY OF THE INVENTION

In accordance with the purposes of the present invention as described herein, a method is provided for distributing beer. The method includes the steps of providing a beer staging structure adjacent a retail location for the beer, stocking beer in the structure and advertising for the beer on the structure. The method may further include refrigerating the beer held in the structure. In addition, the method may include restocking the shelves of the retailer with beer taken from the staging structure.

Still further describing the invention the method may include monitoring the inventory of beer maintained in the structure. This may be done, for example, by detecting the removal of beer from the structure. In addition the method may include providing the structure with an alarm system for sensing unauthorized entry or beer removal.

Further describing the invention, in one embodiment the method may include providing the structure with a first access door for stocking the structure with the beer and a second access door for removing the beer. Typically the first and second access doors are provided at opposite ends of the structure. In one embodiment, the structure may be provided with a floor conveyor to move the beer in the structure from the first or stocking access door to the second or retailer access door as the beer is sold.

In accordance with yet another aspect of the present invention the method includes establishing a radio network for promoting the beer by transmitting promotional information about the beer over a radio frequency from the structure. In addition, the structure may be equipped with a message board and/or a video display device. The message board and/or video display device may be programmed from a remote location. Further the method may include issuing an “Amber Alert” or other public service message over the message board or video display device.

More specifically describing the invention the method may include acquiring a site placement right from a retailer for the retail location. That may include offering the retailer advertising time on the structure. In addition, the method may include marketing the advertising space on the structure and even sharing revenue produced from that marketing with the retailer. Still further, the method may include promoting the sale of beer by informing the public of the increased supply of cold beer available at the retail location.

In the following description there are shown and described preferred embodiments of this invention, simply by way of illustration of two of the modes best suited to carry out the invention. As it will be realized the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWING

The accompanying drawing incorporated in and forming a part of this specification, illustrates several aspects of the present invention and together with the description serves to explain certain principles of the invention. In the drawing:

FIG. 1 is a perspective view of a beer staging structure provided adjacent a retail location that sells the beer; and

FIG. 2 is a schematical cross-sectional view of the storage structure of FIG. 1 showing the conveyor floor.

### DETAILED DESCRIPTION OF THE INVENTION

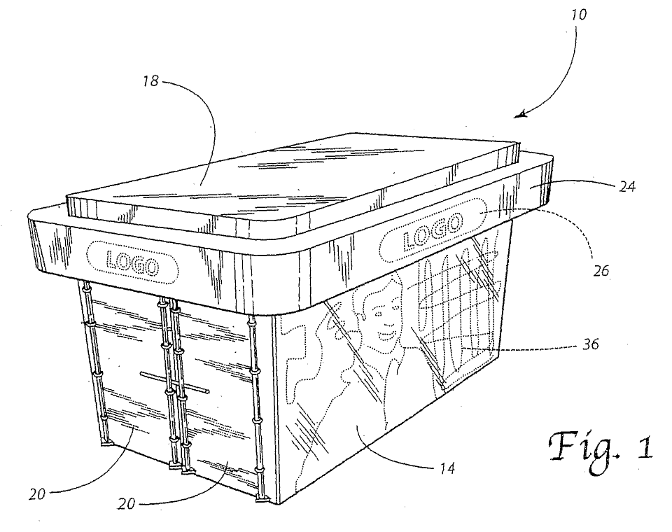

One possible construction of a beer staging structure 10 is illustrated in FIG. 1. More specifically, the structure 10 includes a floor 12, two side walls 14, two end walls 16 and a roof 18. An access door 20 is provided in one of the end walls 16. While a roll type door 20 is illustrated, substantially any type of door useful for the intended purpose may be utilized.

Together the floor 12, side walls 14, end walls 16 and roof 18 define an interior space 22. That interior space 22 may be customized to meet the needs of product vendor including any particular rack, shelving and/or partitioning layouts as required or desired for purposes of inventory storage and control.

The exterior of the structure 10 may be customized to match the trade dress of substantially any desired party and/or architectural features of any building near which the structure may be placed into service. Thus, for example, the structure 10 may include a decorative roof cap 24 sized and shaped to any desired specifications. The roof cap 24 may include advertising, trade dress or a logo 26 if desired and/or as allowed by local regulations.

The structure 10 may also be equipped with various electrical and/or mechanical systems. For example, a climate control unit such as a refrigeration unit 28 may be provided on the structure 10 in order to provide climate control of a portion or all of the space 22 within the structure 10. Thus, beer in the structure 10 may be maintained at a desired serving temperature of between about 32 and about 65° F. This is true even in hot and humid environments.

In addition, the structure 10 may be equipped with a solar panel 30 and cooperating battery 32 to store energy for powering an internal lighting system 34 for illuminating the space 22. Alternatively, the various electrical components of the structure 10 may also derive their power from tapping into the lines of the local electrical utility company and/or from connection with some other form of electric generator. That electric generator may be powered by substantially any known fuel including but not limited to natural gas, propane or fuel cell.

An electronic display device such as a message board or video display device 36 may be mounted on the surface of the side wall 14, end wall 16 or door 20 or recessed in a cavity in such a wall. A transparent, shatterproof shield 39 may be provided over the device 36 to protect it from vandalism. The video display device 36 may take substantially any appropriate form including but not limited to a liquid crystal display or a plasma monitor. The device 36 may also include one or more speakers 41 for the presentation of audio. Thus, audio/video advertising is possible. In this way, TV-like advertising is brought out of the home to a potential customer at or near a point of sale where it can be most effective.

Still further, the structure 10 may incorporate a radio transmitter 38 for the transmission of audio such as low wattage transmission on 89.1 FM in order to establish a radio network for promoting the beer product. Such a network is a particularly effective marketing tool when one considers that literally thousands of these structures may be placed at thousands of locations around the country. Some or all of the structures may be equipped to transmit the promotional programming into the automobiles of prospective purchasers via the radio or even the cell phone.

The structure 10 may be constructed, for example, from modular building materials such as prefabricated panels 40 of the type shown and described in, for example, U.S. Pat. No. 6,279,287 to Meadows, U.S. Pat. No. 5,373,678 to Hesser and U.S. Pat. No. 6,119,427 to Wyman et al. Such modular panels 40 typically incorporate a core of thermal insulating material sandwiched between metal or plastic sheathing. Such a construction provides both efficient and effective control of the temperature and humidity of the environment in the internal space 22 and excellent inclement weather durability for a long, low-maintenance service life. Structures 10 constructed from such modular building panels 40 are also characterized by high strength and will resist high winds and maintain a weather-tight enclosure to protect products held in the space 22 from inclement weather. In fact, such structures may be easily anchored to the ground such as by means of cooperating nut and bolt anchors where the bolt is received and held in an underlying poured concrete pad. The modular panels 40 also allow the structure 10 to be quickly and easily erected and subsequently removed in a minimal amount of time while producing a minimum of mess.

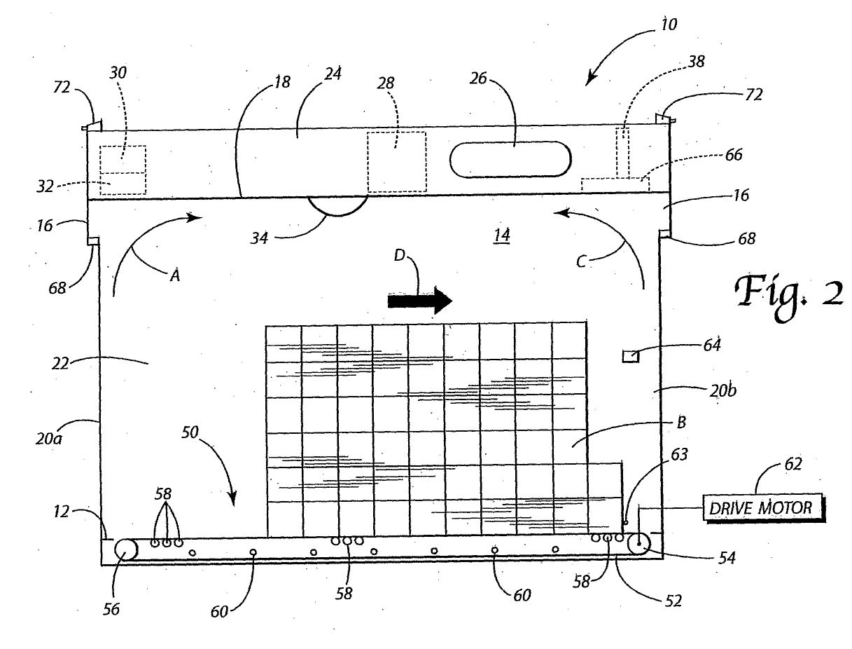

Reference is now made to FIG. 2 illustrating an alternative embodiment and various control features that may be incorporated into the structure 10.

As illustrated in the FIG. 2 embodiment, the structure 10 incorporates a first access or inventory stocking door 20a and a second or retailer restocking access door 20b. As illustrated the two access doors 20a, 20b are provided at opposite ends 16 of the structure 10. After positioning the structure 10 at the desired site adjacent a retail store, the beer supplier opens the inventory stocking door 20a (note action arrow A) and fills the structure 10 with beer B. After filling the structure the stocking door 20a is closed and locked.

Either an employee of the beer supplier or the retailer opens the retailer access door 20b (note action arrow C) and removes beer B from the structure 10 to stock the shelves at the adjacent retail location as needed. Following removal the retailer access door 20b is also closed and locked.

As illustrated in FIG. 2, the structure 10 is equipped with a conveyor floor generally designated by reference numeral 50. As illustrated the conveyor floor 50 includes a conveyor belt 52, a drive roller 54, an idler roller 56, a series of support rollers 58, a series of return rollers 60 and a drive motor 62. When the beer supplier returns to the structure 10 to restock the beer, the conveyor floor 50 is activated to advance any remaining beer inventory in the direction of action arrow D from the inventory stocking door 20a toward the retailer access door 20b. An electric eye or other proximity sensor 63 can be provided to automatically defeat operation of the conveyor floor 50 when the beer approaches the end wall 16 by the retailer access door 20b. The supplier then opens the inventory stocking door 20a and fills the structure 10 with a new supply of beer. This method insures that inventory is used on a first-in and first-out basis.

The structure 10 may also be equipped with an inventory monitoring system. That inventory monitoring system may take any number of forms including, for example, a bar code scanner 64 provided adjacent the retailer access door 20b. When the retailer or restocker 20b removes beer from the structure 10 the retailer runs the beer past the bar code scanner 64 which sends a signal to a controller 66. The controller 66 can then send a signal via hard wire, wireless internet connection or other means to the beer supplier so as to notify the beer supplier that the retailer or restocker is removing beer from the structure 10. By monitoring beer removals the beer supplier knows when to return to the structure 10 to restock the beer.

It should also be noted that the structure 10 may be equipped with an alarm system. The alarm system may include sensors 68 to detect the jimmying of any lock or the unauthorized opening of any door 20a, 20b. The sensor 68 may be connected to the controller 66 which automatically contacts the beer supplier and/or local law enforcement in the event of a break-in. Once again, it should be appreciated that the contact may be made by hard wire, wireless internet connection, telephone connection or any other appropriate means. Of course, if desired, the structure 10 may also include one or more security cameras 72.

The present method of distributing beer comprises the steps of providing a beer staging structure 10 adjacent a retail location from which the beer is sold, stocking beer in the structure and advertising for the beer on the structure. The method may also include maintaining the beer in the structure at a desired serving and/or storing temperature of between about 32 and about 65° F. This may be done by refrigerating the interior space 22 of the structure.

As also noted the method may also include monitoring the inventory of beer maintained in the structure 10. That monitoring may include detecting removal of the beer from the storage structure. In the previously described embodiment, the monitor in question is a bar code scanner. This is exemplary of just one possible monitoring system that may be utilized and the invention should not be considered as being limited thereto.

As also previously noted the structure 10 may be provided with an alarm system for sensing unauthorized entry. Such a system may include security cameras 72 and a controller 66 that functions to contact the beer supplier and/or local law enforcement in the event of the detection of any unauthorized entry.

As also described above and illustrated in FIG. 2, the structure 10 may be provided with a first access door 20a for stocking the structure with beer and a second access door 20b for removing the beer from the structure and restocking of the shelves in the retailer's store. The first and second doors may be provided at opposite ends of the structure and the floor of the structure may include a floor conveyor 50.

In accordance with an additional aspect of the present method there is the step of establishing a radio network for promoting the beer by transmitting promotional information about the beer over a radio frequency from the structure 10. Still further, the method includes the steps of equipping the structure 10 with a message board and remotely programming the message board. This allows one to change the message board message at any desired time from a remote location. This allows tremendous flexibility including the possibility of issuing an “Amber Alert” or other emergency or public service message over the message board.

Similarly, the method may include equipping the structure with a video display device such as a plasma monitor, a liquid crystal display or an LED display. The method may also include remotely controlling the programming over the video display device. Once again this allows flexibility in advertising or for other purposes. For example, in the event of an “Amber Alert”, details respecting the situation including photographs of the missing child and/or presumed abductor may be displayed over the video display device. Where such structures 10 are provided at convenience stores and gas stations located along the exits of an interstate highway, such a system can be particularly effective in the safe return of the missing child and apprehension of the suspect.

In accordance with additional aspects, the present method includes the acquiring of a site placement right from a retailer for the retail location. The acquiring may include offering the retailer advertising time on the structure. Thus, the retailer may wish to advertise a special on sausage and biscuits in the morning and/or a special on fried chicken from the deli in the afternoon. The programmable video display or message boards allow such advertising flexibility including the possibility of time sensitive advertising.

In addition the method may include the marketing of advertising space on the structure. Accordingly, the owner or operator of the structure 10 may market advertising to another entity for products other than the beer that is staged in the structure. Thus, for example, a soft drink manufacturer may purchase advertising time on the side of the structure 10. As incentive for acquiring the site placement right, it is possible for the owner or operator to share the revenue produced from the marketing of advertising space with the retailer.

Still further, the method may include the step of promoting the sale of beer by informing the public of the increased supply of cold beer available at the retail location. Such a promotion has a strong tendency to increase sales of beer and foot traffic at the retail location. This is because consumers often wish to purchase cold beer that is ready to drink at a desired serving temperature.

The foregoing description of a preferred embodiment of the present invention has been presented for purposes of illustration and description. It is not intended to be exhaustive or to limit the invention to the precise form disclosed. Obvious modifications or variations are possible in light of the above teachings. For example, the staging structure 10 could be equipped with a rotary sign assembly such as disclosed in U.S. Pat. No. 4,021,946. Such a three-sided sign allows the periodic display of three different advertisements. Further, the conveyor floor 50 could be formed by a series of aligned rollers allowing one to simply push product across the floor over the rollers.

The embodiments were chosen and described to provide the best illustrations of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims and their fair and broad interpretation in any way.

What is claimed:

1. A method of distributing beer, comprising:
providing a beer staging structure adjacent a retail location that sells said beer;
stocking beer in said structure; and
advertising for said beer on said structure.

2. The method of claim 1 including refrigerating said beer held in said structure.

3. The method of claim 1, including monitoring inventory of beer maintained in said structure.

4. The method of claim 3, including detecting removal of said beer from said structure.

5. The method of claim 1, including providing said structure with an alarm system for sensing unauthorized entry.

6. The method of claim 1, including providing said structure with a first access door for stocking said structure with said beer and a second access door for removing said beer.

7. The method of claim 6, including providing said first and second access doors at opposite ends of said structure.

8. The method of claim 7, including providing said structure with a floor conveyor.

9. The method of claim 1, including establishing a radio network for promoting said beer by transmitting promotional information about said beer over a radio frequency from said structure.

10. The method of claim 1, including equipping said structure with a message board.

11. The method of claim 10, including remotely programming said message board.

12. The method of claim 11, including issuing an “Amber Alert” message over said message board.

13. The method of claim 1, including equipping said structure with a video display device.

14. The method of claim 13, including remotely controlling programming over said video display device.

15. The method of claim 14, including issuing an “Amber Alert” message over said video display device.

16. The method of claim 1, including acquiring a site placement right from a retailer for said retail location.

17. The method of claim 16, including offering said retailer advertising time on said structure.

18. The method of claim 16, including marketing advertising space on said structure.

19. The method of claim 18, including sharing revenue produced from said marketing of advertising space with said retailer.

20. The method of claim 1, including promoting sale of said beer by informing public of increased supply of cold beer available at retail location.

21. The method of claim 1, including restocking said retailer with beer taken from said staging structure.
